(19) United States
(12) Patent Application Publication
(10) Pub. No.: US 2017/0032386 A1
(43) Pub. Date: Feb. 2, 2017

(54) Growth-based ranking of companies

(71) Applicant: Paul Valentin Borza, Redmond, WA (US)

(72) Inventor: Paul Valentin Borza, Redmond, WA (US)

(21) Appl. No.: 14/815,992

(22) Filed: Aug. 1, 2015

(51) Int. Cl. G06Q 30/02; G06N 99/00; G06F 17/30

(52) U.S. Cl. CPC G06Q 30/0201; G06F 17/3053; G06N 99/005

(57) ABSTRACT

Finding early-stage companies (i.e. startup companies) on track to becoming successful may be achieved by predicting future growth of the Internet assets owned or associated with a company. Machine learning algorithms like regression analysis techniques may be employed on past discrete-time data depicting growth of the assets, such as daily page views of the official website of the company and number of downloads of the company applications made available in mobile application stores, in order to predict future growth. A growth score which depicts potential future business success of a company may be generated and sorted by so that the companies are ranked into an ordered list. Further, job listings from each of the companies may be nested in the ranked list of the companies, which allows career-driven professionals to discover and join startup companies on track to becoming successful at a very early stage.

### BACKGROUND OF THE INVENTION

There's little public information available to career-driven professionals about early-stage companies (i.e. startup companies). Investors however have access, usually under a nondisclosure agreement, to key internal performance indicators; such business projections are made available to investors by the founders themselves during pitches and funding rounds.

A way to find jobs on the Internet is via job search engines. Current state of the art job search engines sort job postings either by relevance, date or location. In the case of job search engines, it's common for relevance to be a measurement of how well the user's query matches the title and description of the job posting (i.e. keyword matching). This is the de facto way generic search engines work in order to rank the most relevant web pages or documents at the top. The approach works great for generic search engines and was transferred to job postings, but it's far from enough for career-driven professionals to find jobs in rising startups.

So investors have an unfair advantage over career-driven professionals when it comes to knowing which companies are likely to succeed and make sustainable profits. The sooner someone joins a startup company, the more equity someone gets, thus the bigger the payout is once the company goes public, but so is risk. Given that current job search engines don't take metrics concerning potential future success of companies into account, prospective candidates may apply for positions in less successful startups.

### BRIEF SUMMARY OF THE INVENTION

The following presents a simplified summary in order to provide a basic understanding of some novel implementations described herein. The summary is not an extensive overview, and it is not intended to identify key/critical elements or to delineate the scope thereof. Its sole purpose is to present some concepts in a simplified form as a prelude to the more detailed description that is presented later.

The disclosed architecture estimates future business success of a company in the form of a score which is used to rank the companies. Since internal business metrics aren't available to the public, a novel heuristic method for ranking companies is presented. Given discrete-time data reflecting the usage of the Internet assets of a company is available for public consumption, a plurality of statistical analysis methods and machine learning techniques may be employed to generate a score which denotes how fast a company is growing. The faster the company is growing, the better the chances of success, since more and more users love their products every day.

Even though internal business metrics aren't available to the public in order to properly rank startup companies against each other, future success of a company can still be quantified by fitting trend functions on past data collected from the Internet assets owned or associated with the company (e.g. websites, mobile applications or social media accounts). This in turn allows for machine learning techniques to interpret trend coefficients and further predict a growth score which correlates to the potential future success of a company. For example, if a trend line was fitted on growth data of the assets, the slope of the line may be used as score, so that the steepness of the line denotes how fast the company is growing. This final per company growth score may then be further used in ranking the companies.

The ranked list of companies may be augmented with job listings from each of the companies in addition to comprising charts and trends depicting the growth of companies.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a method in accordance with the disclosed architecture.

FIG. 2 illustrates an alternative method in accordance with the disclosed architecture.

FIG. 3 illustrates an example view of ranked companies in accordance with the disclosed architecture.

FIG. 4 illustrates another example view of ranked companies augmented with job listings in accordance with the disclosed architecture.

FIG. 5 illustrates a system in accordance with the disclosed architecture.

### DETAILED DESCRIPTION OF THE INVENTION

Current state of the art job search engines generally rank job listings either by relevance, date, location or average rating of the company posting the job listing. Big companies which have been in the industry for several years have the benefit of a renowned name which resonates with people, making talent acquisition easier, whereas early-stage companies (i.e. startup companies) are fairly unknown. Given the above, when prospective employees search for jobs, they're unlikely to apply for jobs in companies not known to them because of the lack of trust. However, there's a silver lining to startup companies, in that the sooner someone joins an early-stage company, the more equity someone gets, thus the bigger the payout is once the company goes public, but so is risk.

There's little to no public information available on the Internet about key internal business metrics to properly quantify potential future success of a startup company. This forces prospective employees to make empirical career decisions which can turn out to be devastating in the long run. At the same time, joining a startup company which is on the verge of becoming a worldwide phenomenon can yield a lot more monetary returns than working for a big company on a fixed income.

To help prospective employees make data-driven career decisions, a novel method and system is presented which calculates a score representing potential future business success of a company. This score may be further used to rank companies amongst them so that career-driven professionals become aware of companies which are on track to become very successful.

Success is often measured in terms of profit, which translates to customers who have bought the product(s) or subscribed to the service(s) offered by a company. (Other ways of measuring success is popularity or money raised during funding rounds, but it eventually comes down to profit.) As both profit and customers qualify as key internal business metrics, they're not publicly available to candidates. However, the relative increase in number of users, and ultimately customers, may be estimated based on the growth of the Internet assets owned or associated with a company. At a minimum, a startup company should have an Internet website, in which case the number of daily page views can be procured from traffic monitoring providers. Moreover, other discrete-time metrics representing website traffic information may be used, like number of sessions, unique visitors etc.

However, a single instance of website traffic information does not allow for prediction of potential future business success, but a discrete-time series of data measuring traffic information may. As such, a trend function may be fitted on past data points via regression analysis, enabling the usage of its coefficients to measure the rate of which the company is growing. For example, if the function would be linear, then the slope of the trendline may be used as growth factor. Since different companies grow at different speeds, the companies can be sorted into an either ascending or descending ranked list of companies denoting the slowest growing companies, and respectively the fastest growing companies.

Described above is a scenario where growth is estimated based on daily page views from an Internet asset, specifically the official website of the company. However, this is not to be construed as limiting, in that there are many more possible Internet assets and growth metrics, such as:
Application(s) of the company made available to consumers in mobile application store(s), where growth metrics may comprise number of downloads, reviews, and/or comments.
Physical or virtual product(s) (e.g. 3D models, website themes etc.) of the company made available on Internet marketplaces, where growth metrics may comprise number of sales, downloads, reviews, and/or comments.
Social media account(s) of the company made available on Internet social websites, where growth metrics may comprise number of posts, re-posts, photos, videos, and/or followers, and for those types of social activity the number of views, likes, upvotes, and/or comments, if applicable.
Blog(s) of the company made available on the Internet, where growth metrics may comprise number of posts, views, and/or comments.
Feedback channel(s) for the company made available on public user forums, where growth metrics may comprise number of feedbacks, views, upvotes, and/or comments.
Code repository(ies) of the company made available on public repository hosting services, where growth metrics may comprise number of authors, collaborators, watchers, stars, and/or code forks. Moreover, code repositories can optionally include tutorials, specifications or anything else the authors may deem relevant for augmenting code.
News related to the company posted on the Internet, where growth metrics may comprise number of publishers posting the news, views, and/or comments. It is to be understood that news may also refer to successful funding rounds where the company has raised money from investors; in aggregate, funding rounds indicate the valuation of a company which may be used as one of the growth metrics.

When textual data is collected from Internet assets such as those outlined above, growth metrics may be calculated after running sentiment analysis technique(s) on said textual data. This allows for a better segmentation as growth data may be measured solely on positive and/or negative textual data items.

If multiple discrete-time growth data series are used to predict the potential future success of a company, multivariable (not to be confused with multivariate) regression analysis technique(s) may be employed. For example, both daily page views of the official website of the company and daily number of downloads of the application(s) made available in mobile application store(s) by the company, may be fed as input to multivariable regression analysis technique(s) in order to produce the final score denoting potential future success of the company. Any time interval (e.g. monthly, weekly, daily, hourly etc.) may be used in the collection of data points depicting growth from the Internet assets owned or associated with the company.

Alternative embodiments of the disclosed architecture may employ other machine learning techniques where factor analysis may be exercised, in order to reduce the large number of series and/or features calculated on the discrete-time growth data series to a smaller set of variables which have the highest correlation with predicting potential future business success of companies. The machine learning algorithms may then yield a growth score for each company which may then be further used to rank the companies amongst them.

Apart from generating a growth-based score representing potential future business success for each of the companies, the score may also be interpreted as an assessment depicting growth rates. For example, a company may be classified as having a “high”, “medium”, or “low” growth rate; such a classification may be inferred based on chosen thresholds for scores given to companies. These example assessments should not be construed as limiting as other growth classifications may exist. Moreover, when a company has low or negative growth, the risk of joining such a company is high since its future is uncertain; so risk assessments can be calculated as being the inverse of growth assessments.

The growth-based score may also be translated into growth ranks once the companies have been sorted into a ranked list. For example, the fastest growing company will be ranked #1, the second-fastest growing company will be ranked #2 and so on.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

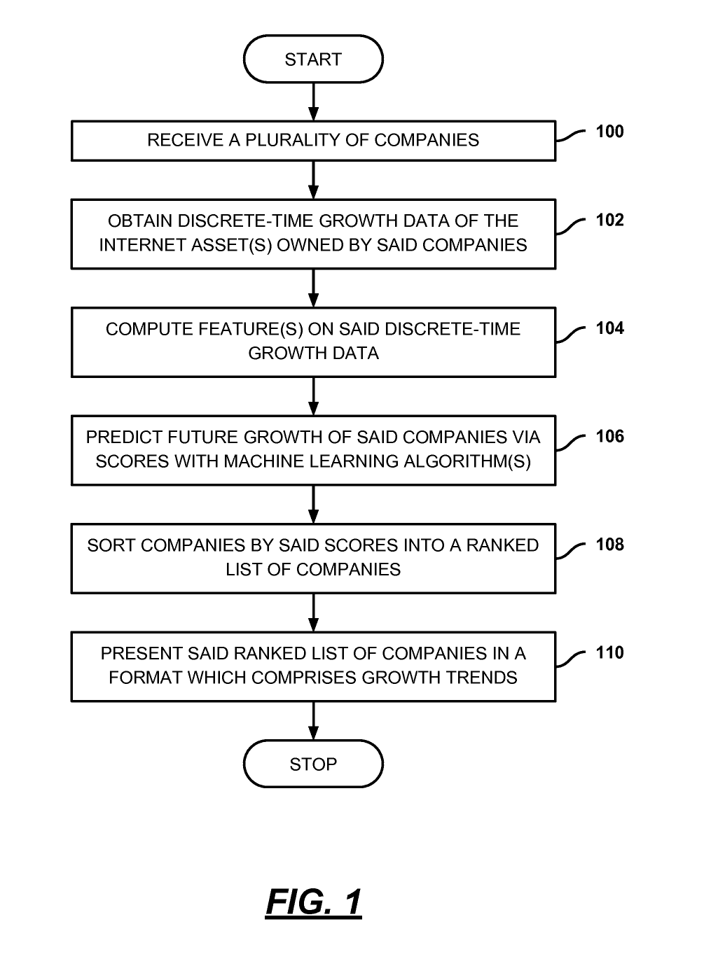

FIG. 1 illustrates a method in accordance with the disclosed architecture. At 100, information about a plurality of companies is received, information which may comprise the name and official website of each company. The method for receiving such information may be either a push, pull, or hybrid data flow model.

At 102, a single or multiple discrete-time series of data depicting the growth of the Internet assets owned or associated with each company is obtained. The start and end date of the discrete-time data series depicting growth may be different across assets within the same company or across multiple companies. Also, the discrete-time data series may be obtained in different units (e.g. every day, every hour, every minute etc.). If this is the case, the novel architecture may account for such discrepancies as missing or non-normalized data. The process for obtaining growth data may be done by repeatedly scraping the Internet assets for information or procured in bulk from data intelligence providers, such as traffic monitoring services, or shared privately or publicly by the companies themselves.

At 104, raw growth data may be processed into features which are measurable properties of the observed growth data. It is to be understood that to the extent of the definition of features used in machine learning algorithms, even raw data may qualify as features. For example, a feature may be considered to be the longest streak of days in which the number of page views of the official website of the company never regressed. The growth data, as well as the final growth score, may be normalized by properties of companies, like number of employees or funding rounds.

At 106, machine learning algorithm(s) may be employed in order to predict for each company its future growth via a score. As indicated before, univariable or multivariable regression analysis technique(s) may be applicable, but those skilled in the art of machine learning will understand that other technique(s) are equally applicable as long as the output comprises a score which depicts potential business success in the form of predicted future growth. The lowest score may represent the fastest growing company or the lowest score may represent the slowest growing company (and the inverse applies for the highest score); either way, the meaning of the value of the score will influence the sorting order.

At 108, once a growth score has been predicted for each company, the companies may be sorted based on said scores. The sorting order, as indicated above, may be chosen to be ascending or descending so that either the fastest or slowest growing companies are on the first positions of the ranked list of companies.

At 110, the ranked list of companies may be presented via means of a graphical user interface in a format which comprises graphical growth trends. For example, for each company, a discrete-time data series depicting the growth of an Internet asset may be chosen and plotted on a chart; a trend function may further be overlaid on the series. This helps career-driven professionals grasp the growth rate visually, and easily determine which company is growing faster than the other.

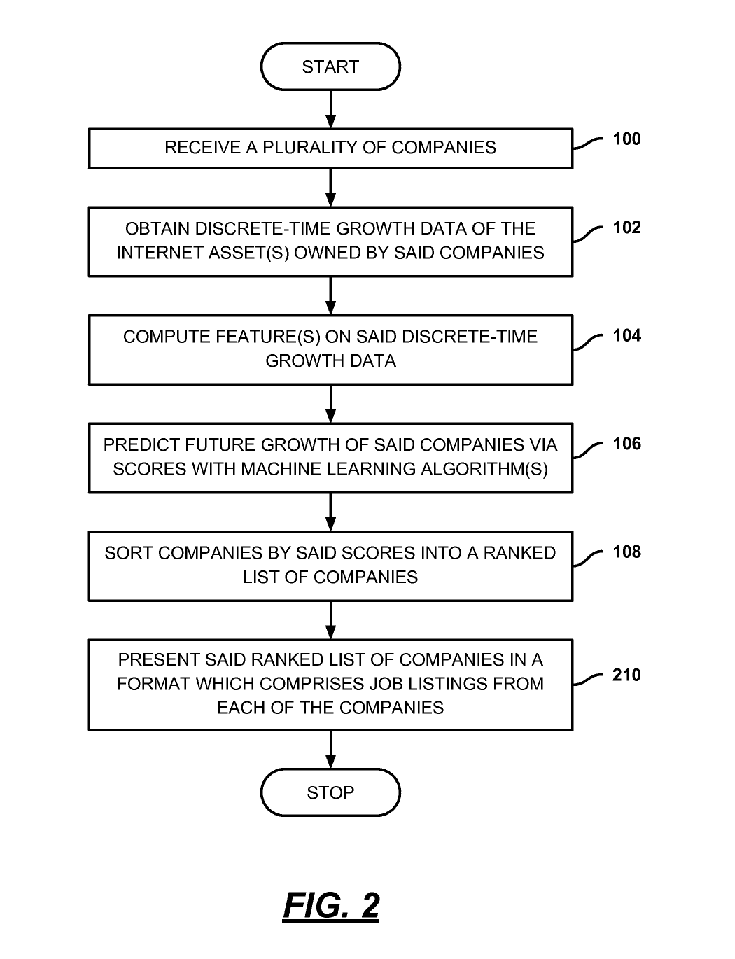

FIG. 2 illustrates an alternative method in accordance with the disclosed architecture. At 210, the ranked list of companies may be presented via means of a graphical user interface in a format which comprises job listings from each of the companies. The job listings for each of the companies may be displayed as sublists, where each sublist of job listings representing open positions at a company, may be merged with or nested in the ranked list of companies as long as the list of jobs from the fastest growing company show up before (or after, depending on the sorting order) the list of jobs from the second-fastest growing company, and so on.

The word “exemplary” may be used herein to mean serving as an example, instance, or illustration. Any aspect or design described herein as “exemplary” is not necessarily to be construed as preferred or advantageous over other aspects or designs.

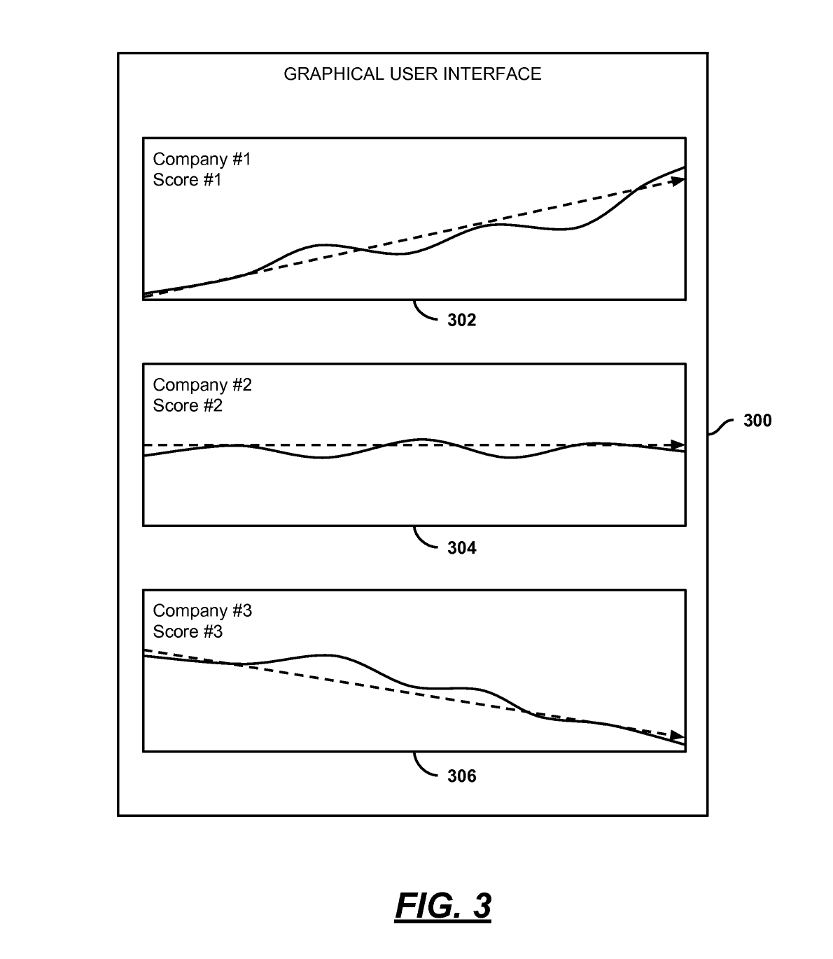

FIG. 3 illustrates an exemplary graphical user interface 300 showing information about companies which are ranked by their corresponding growth scores in accordance with the disclosed architecture. In this example, the graphical user interface 300 comprises chart 302 representing a fast-growing company, chart 304 representing a company with no growth, and chart 306 representing a company with negative growth. The names and growth scores of the companies may be displayed as the title and subtitle of the charts.

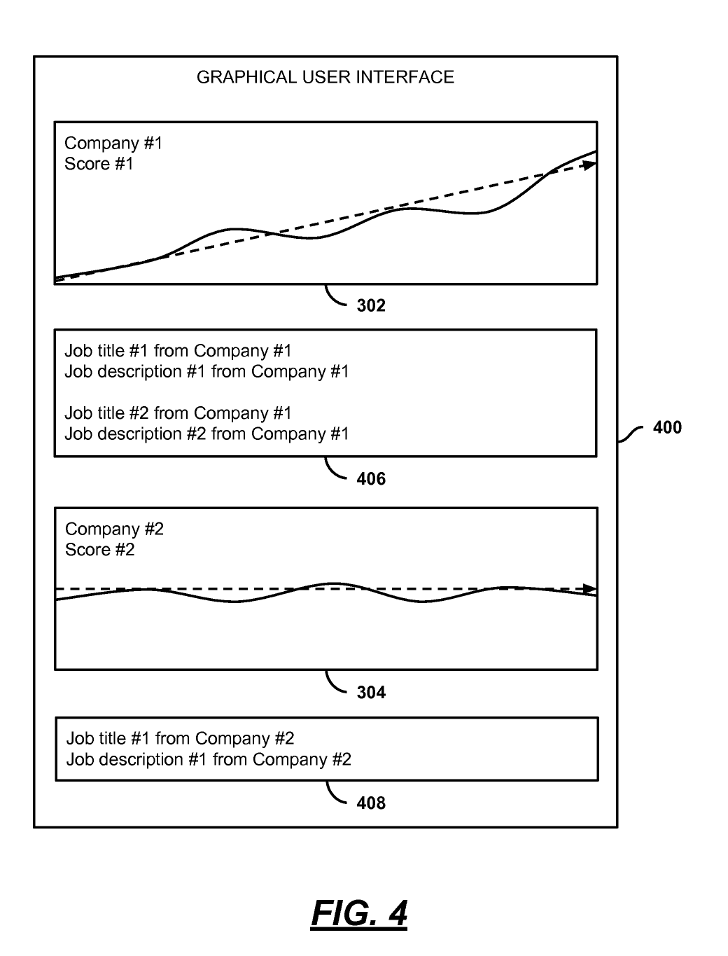

FIG. 4 illustrates another exemplary graphical user interface 400 showing information about companies which are ranked by their corresponding growth scores, and associated job listings from each of the companies, in accordance with the disclosed architecture. In this example, the graphical user interface 400 further comprises job listings 406 and 408 in the form of sublists nested under charts 302 and 304 respectively. Job listings 406 associated with the company depicted in chart 302 are displayed before the job listings 408 associated with the company depicted in chart 304, per a descending sorting order where the largest score is given to the fastest growing company.

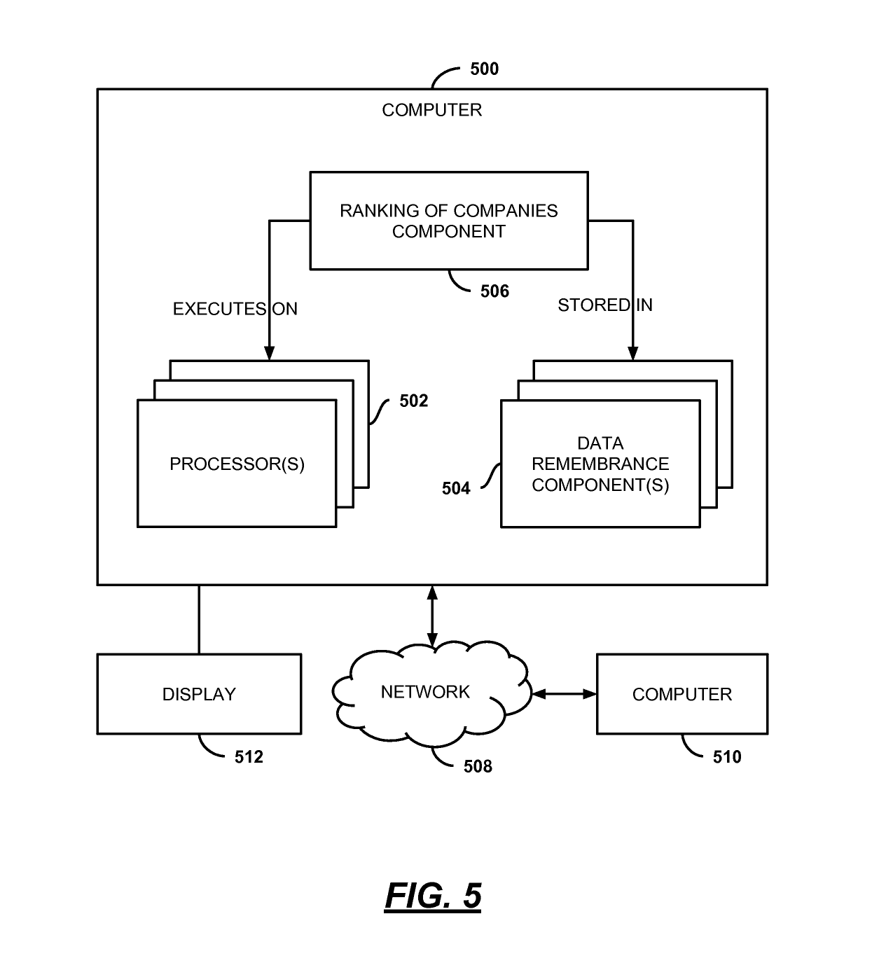

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server computer, a handheld computer or another kind of computing device. Data remembrance component(s) 504 are components that are capable of storing data for either the short or long term. Examples of data remembrance component(s) 504 include hard disks, removable disks (including optical and magnetic disks), volatile and nonvolatile random-access memory (RAM), read-only memory (ROM), flash memory, magnetic tape etc. Data remembrance component(s) are examples of computer-readable storage media. Computer 500 may comprise, or be associated with, display 512, which may be a cathode ray tube (CRT) monitor, a liquid crystal display (LCD) monitor or any other type of monitor.

Software may be stored in the data remembrance component(s) 504, and may execute on the one or more processor(s) 502. An example of such software is ranking of companies 506, which may implement some or all of the functionality described above in connection with FIGS. 1-2, although any type of software could be used. Software 506 may be implemented, for example, through one or more components, which may be components in a distributed system, separate files, separate functions, separate objects, separate lines of code etc. A computer (e.g. personal computer, server computer, handheld computer etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium.

The term “computer-readable media” does not include signals per se; nor does it include information that exists solely as a propagating signal. It is noted that there is a distinction between media on which signals are “stored” (which may be referred to as “storage media”), and—in contradistinction—media that exclusively transmit propagating signals without storing the data that the signals represent. DVDs, flash memory, magnetic disks etc., are examples of storage media. On the other hand, the fleeting, momentary physical state that a wire or fiber has at the instant that it is transmitting a signal is an example of a signal medium. (Wires and fibers can be part of storage media that store information durably, but information that exists only as the fleeting excitation of electrons in a wire, or only as the pulse of photons in a fiber, constitutes a signal.) It will be understood that, if the claims herein refer to media that carry information exclusively in the form of a propagating signal, and not in any type of durable storage, such claims will use the term “signal” to characterize the medium or media (e.g. “signal computer-readable media” or “signal device-readable media”). Unless a claim explicitly uses the term “signal” to characterize the medium or media, such claim shall not be understood to describe information that exists solely as a propagating signal or solely as a signal per se. Additionally, it is noted that “hardware media” or “tangible media” include devices such as RAMs, ROMs, flash memories and disks that exist in physical, tangible form, and that store information durably; such “hardware media” or “tangible media” are not signals per se, are not propagating signals, and these terms do not refer media in which information exists exclusively as a propagating signal. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs etc., but does not include information that exists only in the form of a propagating signal because such information is not “stored”.

Additionally, any acts described herein (whether or not shown in a diagram) may be performed by a processor (e.g. one or more of processors 502) as part of a method. Thus, if the acts A, B and C are described herein, then a method may be performed that comprises the acts A, B and C. Moreover, if the acts of A, B and C are described herein, then a method may be performed that comprises using a processor to perform the acts of A, B and C.

In one example environment, computer 500 may be communicatively connected to one or more devices through network 508. Computer 510, which may be similar in structure to computer 500, is an example of a device that can be connected to computer 500, although other types of devices may also be connected.

In one example, the subject matter herein may take the form of a method for ranking companies, where the method comprises: receiving a plurality of companies; obtaining discrete-time growth data of the Internet asset(s) owned or associated with said companies; computing feature(s) on said discrete-time growth data; predicting future growth of said companies via scores with machine learning algorithm(s); sorting companies by said scores into a ranked list of companies. The method may also comprise presenting said ranked list of companies in a format which comprises growth scores. The method may also comprise presenting said ranked list of companies in a format which comprises growth ranks. The method may also comprise presenting said ranked list of companies in a format which comprises growth or risk assessments. The method may also comprise presenting said ranked list of companies in a format which comprises graphical growth trends. The method may also comprise presenting said ranked list of companies in a format which comprises job listings from each of the companies. The machine learning algorithm(s) referred above may comprise regression analysis algorithm(s) wherein said feature(s) may comprise said raw discrete-time growth data in order for each said score to be a function of the coefficient(s) of the regression function(s).

In another example, the subject matter herein may take the form of a storage medium that is readable by a device, that stores executable instructions to rank said companies, where the executable instructions, when executed by said device, cause the device to perform acts comprising: receiving a plurality of companies; obtaining discrete-time growth data of the Internet asset(s) owned or associated with said companies; computing feature(s) on said discrete-time growth data; predicting future growth of said companies via scores with machine learning algorithm(s); sorting companies by said scores into a ranked list of companies. The acts performed by the instructions may also present said ranked list of companies in a format which comprises growth scores. The acts performed by the instructions may also present said ranked list of companies in a format which comprises growth ranks. The acts performed by the instructions may also present said ranked list of companies in a format which comprises growth or risk assessments. The acts performed by the instructions may also present said ranked list of companies in a format which comprises graphical growth trends. The acts performed by the instructions may also present said ranked list of companies in a format which comprises job listings from each of the companies. The machine learning algorithm(s) referred above may comprise regression analysis algorithm(s) wherein said feature(s) may comprise said raw discrete-time growth data in order for each said score to be a function of the coefficient(s) of the regression function(s).

In yet another example, the subject matter herein may take the form of a system that comprises a data remembrance component, a processor, and a ranking of companies component that is stored in the data remembrance component, that executes on the processor, and that is configured to receive a plurality of companies, said component being further configured to obtain discrete-time growth data of the Internet asset(s) owned or associated with said companies, said component being further configured to compute feature(s) on said discrete-time growth data, said component being further configured to predict future growth of said companies via scores with machine learning algorithm(s), said component being further configured to sort companies by said scores into a ranked list of companies. The component may be further configured to present said ranked list of companies in a format which comprises growth scores. The component may be further configured to present said ranked list of companies in a format which comprises growth ranks. The component may be further configured to present said ranked list of companies in a format which comprises growth or risk assessments. The component may be further configured to present said ranked list of companies in a format which comprises graphical growth trends. The component may be further configured to present said ranked list of companies in a format which comprises job listings from each of the companies. The machine learning algorithm(s) referred above may comprise regression analysis algorithm(s) wherein said feature(s) may comprise said raw discrete-time growth data in order for each said score to be a function of the coefficient(s) of the regression function(s).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of ranking companies, the method comprising:
receiving a plurality of companies; and
obtaining discrete-time growth data of the Internet asset(s) owned or associated with said companies; and
computing feature(s) on said discrete-time growth data; and
predicting future growth of said companies via scores with machine learning algorithm(s); and
sorting companies by said scores into a ranked list of companies.

2. The computer-implemented method of claim 1, further comprising:
presenting said ranked list of companies in a format which comprises growth scores.

3. The computer-implemented method of claim 1, further comprising:
presenting said ranked list of companies in a format which comprises growth ranks.

4. The computer-implemented method of claim 1, further comprising:
presenting said ranked list of companies in a format which comprises growth or risk assessments.

5. The computer-implemented method of claim 1, further comprising:
presenting said ranked list of companies in a format which comprises graphical growth trends.

6. The computer-implemented method of claim 1, further comprising:
presenting said ranked list of companies in a format which comprises job listings from each of the companies.

7. The computer-implemented method of claim 1, wherein said machine learning algorithm(s) comprise regression analysis algorithm(s) and wherein said feature(s) comprise said raw discrete-time growth data in order for each said score to be a function of the coefficient(s) of the regression function(s).

8. A computer-readable medium comprising executable instructions to rank companies, the executable instructions, when executed by a computer, causing the computer to perform acts comprising:
receiving a plurality of companies; and
obtaining discrete-time growth data of the Internet asset(s) owned or associated with said companies; and
computing feature(s) on said discrete-time growth data; and
predicting future growth of said companies via scores with machine learning algorithm(s); and
sorting companies by said scores into a ranked list of companies.

9. The computer-readable medium of claim 8, said acts further comprising:
presenting said ranked list of companies in a format which comprises growth scores.

10. The computer-readable medium of claim 8, said acts further comprising:
presenting said ranked list of companies in a format which comprises growth ranks.

11. The computer-readable medium of claim 8, said acts further comprising:
presenting said ranked list of companies in a format which comprises graphical growth trends.

12. The computer-readable medium of claim 8, said acts further comprising:
presenting said ranked list of companies in a format which comprises job listings from each of the companies.

13. The computer-readable medium of claim 8, wherein said machine learning algorithm(s) comprise regression analysis algorithm(s) and wherein said feature(s) comprise said raw discrete-time growth data in order for each said score to be a function of the coefficient(s) of the regression function(s).

14. A system for ranking companies, the system comprising:
a data remembrance component; and
a processor; and
a ranking of companies component that is stored in said data remembrance component, that executes on said processor, and that is configured to receive a plurality of companies,
said component being further configured to obtain discrete-time growth data of the Internet asset(s) owned or associated with said companies,
said component being further configured to compute feature(s) on said discrete-time growth data,
said component being further configured to predict future growth of said companies via scores with machine learning algorithm(s),
said component being further configured to sort companies by said scores into a ranked list of companies.

15. The system of claim 14, said component being further configured to present said ranked list of companies in a format which comprises growth scores.

16. The system of claim 14, said component being further configured to present said ranked list of companies in a format which comprises growth ranks.

17. The system of claim 14, said component being further configured to present said ranked list of companies in a format which comprises growth or risk assessments.

18. The system of claim 14, said component being further configured to present said ranked list of companies in a format which comprises graphical growth trends.

19. The system of claim 14, said component being further configured to present said ranked list of companies in a format which comprises job listings from each of the companies.

20. The system of claim 14, wherein said machine learning algorithm(s) comprise regression analysis algorithm(s) and wherein said feature(s) comprise said raw discrete-time growth data in order for each said score to be a function of the coefficient(s) of the regression function(s).
